(19) United States
(12) Patent Application Publication
(10) Pub. No.: US 2026/0131791 A1
(43) Pub. Date: May 14, 2026

(54) DRIVER STATE ESTIMATION SYSTEM

(71) Applicant: TOYOTA JIDOSHA KABUSHIKI KAISHA, Toyota-shi (JP)

(72) Inventor: Sei KATO, Kawasaki-shi (JP)

(73) Assignee: TOYOTA JIDOSHA KABUSHIKI KAISHA, Toyota-shi (JP)

(21) Appl. No.: 19/277,857

(22) Filed: Jul. 23, 2025

(30) Foreign Application Priority Data
Nov. 14, 2024 (JP) 2024-199059

(51) Int. Cl. B60W 40/08; B60W 50/14

(52) U.S. Cl. CPC B60W 40/08; B60W 50/14; B60W 2050/146; B60W 2540/215

(57) ABSTRACT

A driver state estimation system transmits, in a case where an estimation is made that a problem occurs to a driver, based on a state of a screen operation operated by the driver, of an in-vehicle terminal device mounted in a vehicle, screen information of the in-vehicle terminal device to a call center.

### CROSS-REFERENCE TO RELATED APPLICATION

This application claims priority to Japanese Patent Application No. 2024-199059 filed on Nov. 14, 2024. The disclosure of the above-identified application, including the specification, drawings, and claims, is incorporated by reference herein in its entirety.

### BACKGROUND

### 1. Technical Field

The present disclosure relates to a technical field of a driver state estimation system that estimates a state of a driver of a vehicle.

### 2. Description of Related Art

For example, in a case where the driver of the vehicle has a problem with operation of an in-vehicle terminal device, the driver may make an inquiry to a call center. Japanese Unexamined Patent Application Publication No. 2008-101979 (JP 2008-101979 A) discloses a system. Operation data indicating an operation method for the in-vehicle terminal device is generated at the call center. The operation data is transmitted to the in-vehicle terminal device. As a result, the system causes the in-vehicle terminal device to operate in response to the operation data.

### SUMMARY

The technique described in JP 2008-101979 A has a room for improvement. In the call center, a trained model constructed by machine learning may be used to answer the inquiry made by the driver.

The present disclosure has been made in view of the above circumstances, and an object of the present disclosure is to provide a driver state estimation system capable of reducing a burden on a driver.

A driver state estimation system according to an aspect of the present disclosure transmits, in a case where an estimation is made that a problem occurs to a driver, based on a state of a screen operation operated by the driver, of an in-vehicle terminal device mounted in a vehicle, screen information of the in-vehicle terminal device to a call center.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a configuration of a driver state estimation system according to an embodiment;

FIG. 2 is a flowchart showing an operation at the time of learning of the driver state estimation system according to the embodiment;

FIG. 3 is a diagram showing another example of the configuration of the driver state estimation system according to the embodiment; and

FIG. 4 is a flowchart showing an operation at the time of estimation of the driver state estimation system according to the embodiment.

### DETAILED DESCRIPTION OF EMBODIMENTS

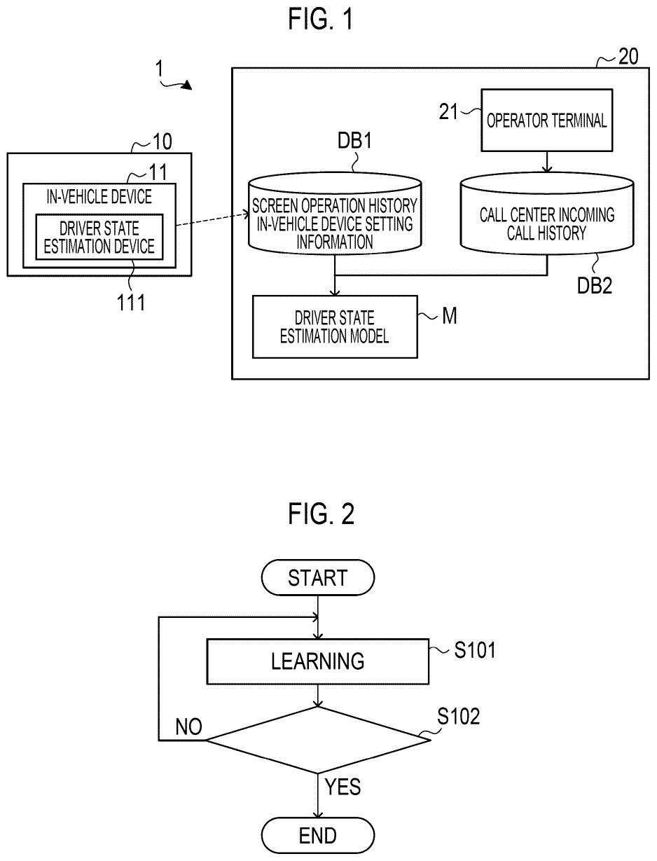

An embodiment of a driver state estimation system will be described with reference to FIGS. 1 to 4. In FIG. 1, the driver state estimation system 1 includes an in-vehicle terminal device 11 (hereinafter, referred to as “in-vehicle device 11” as appropriate) mounted in a vehicle 10 and an operator terminal 21 provided in a call center 20. For example, the in-vehicle device 11 may have a microphone, a speaker, and a communication device. For example, the in-vehicle device 11 may be a navigation device.

### During Learning

First, the learning of a driver state estimation model M in the driver state estimation system 1 will be described. It is assumed that the in-vehicle device 11 does not have the driver state estimation device 111 before the driver state estimation model M is learned.

When the driver of the vehicle 10 has a problem with the operation of the in-vehicle device 11, the driver may make an inquiry to the call center 20 using the in-vehicle device 11. In this case, the driver may make a call to an operator of the call center 20 by using the microphone, the speaker, and the communication device of the in-vehicle device 11. In a case where the inquiry to the call center 20 is made, the in-vehicle device 11 transmits a screen operation history of the in-vehicle device 11 and in-vehicle device setting information to the call center 20. The screen operation history and the in-vehicle device setting information are stored in a database DB1. In addition, the operator of the call center 20 may input the information regarding the inquiry of the driver by using the operator terminal 21. The information regarding the inquiry of the driver is stored in a database DB2 as a call center incoming call history. The databases DB1, DB2 may be implemented by a server. In this case, the databases DB1, DB2 may be implemented by a single server or may be implemented by a plurality of servers.

The screen operation history and the in-vehicle device setting information are sufficiently accumulated in the database DB1. The call center incoming call history is sufficiently accumulated in the database DB2. Thereafter, the call center 20 (for example, a server provided in the call center 20) uses the screen operation history, the in-vehicle device setting information, and the call center incoming call history as training data to train the driver state estimation model M.

The driver state estimation model M may be a rule-based model or may be a model constructed by machine learning. Alternatively, the driver state estimation model M may be a model constructed by fine-tuning a base model using the screen operation history, the in-vehicle device setting information, and the call center incoming call history as training data.

The training for the driver state estimation model M will be described with reference to the flowchart of FIG. 2. The operation shown in FIG. 2 may be performed by a server provided in the call center 20, for example. In FIG. 2, the server uses the screen operation history, the in-vehicle device setting information, and the call center incoming call history as the training data to train the driver state estimation model M (S101). Next, the server determines whether the constructed driver state estimation model M can estimate the driver state (S102).

In the processing of S102, a determination may be made whether the driver state can be estimated based on an evaluation index related to the constructed driver state estimation model M. In a case where determination is made in the processing of S102 that the driver state cannot be estimated (S102: No), the processing of S101 is performed.

In a case where determination is made in the processing of S102 that the driver state can be estimated (S102: Yes), the operation shown in FIG. 2 is ended. Thereafter, the constructed driver state estimation model M may be distributed to a plurality of vehicles including the vehicle 10. As a result, for example, the in-vehicle device 11 of the vehicle 10 has the driver state estimation device 111 using the constructed driver state estimation model M.

### During Estimation

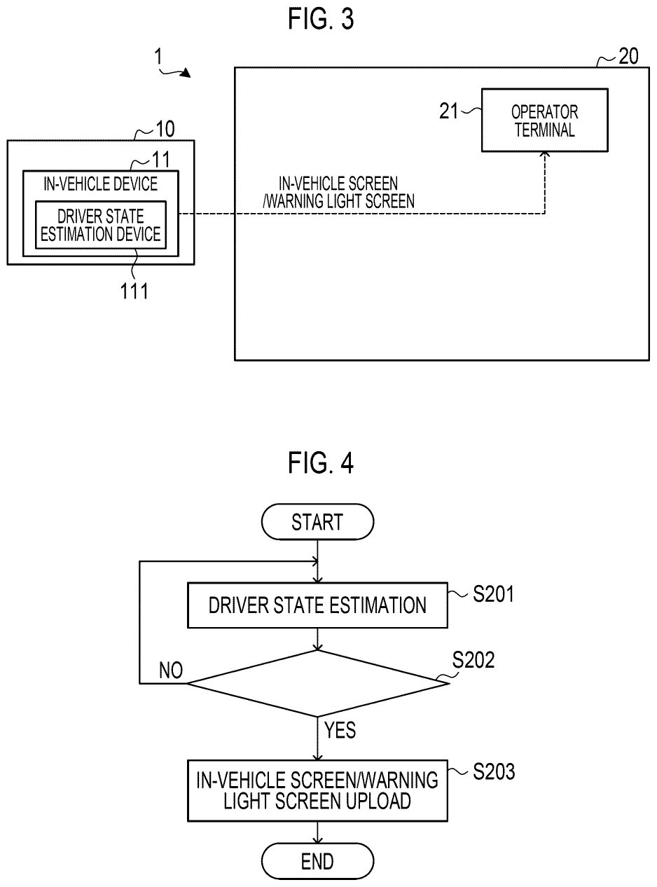

Next, the operation of the in-vehicle device 11 having the driver state estimation device 111 will be described with reference to FIGS. 3 and 4. The driver state estimation device 111 of the in-vehicle device 11 estimates the driver state in a case where the driver of the vehicle 10 operates a screen (that is, a touch panel) of the in-vehicle device 11 (S201). In this case, the driver state estimation device 111 may output a confidence level depending on the estimated driver state.

For example, in a case where the driver repeatedly presses a connection button on the setting screen of Bluetooth (registered trademark), the driver state estimation device 111 may estimate that the driver has a problem with the connection of Bluetooth. For example, in a case where the driver repeatedly adjusts a volume, the driver state estimation device 111 may estimate that the driver has a problem with the adjustment of the volume. For example, in a case where the driver repeatedly operates an on/off button of an air conditioner, the driver state estimation device 111 may estimate that the driver has a problem with the operation of the air conditioner.

After the processing of S201, the in-vehicle device 11 determines whether the confidence level regarding the estimated driver state is equal to or higher than a threshold value that is predetermined (S202). In the processing of S202, when determination is made that the confidence level is smaller than a threshold value that is predetermined (S202: No), the processing of S201 is performed.

In the processing of S202, when determination is made that the confidence level is equal to or higher than a threshold value that is predetermined (S202: Yes), the in-vehicle device 11 uploads at least one of the screen of the in-vehicle device 11 and a warning light screen to the operator terminal 21 of the call center 20 (S203). Here, the processing of S203 is performed before the driver of the vehicle 10 makes an inquiry to the call center 20.

For example, in a case where the driver state estimation device 111 estimates that the driver has a problem with the Bluetooth connection, the in-vehicle device 11 may upload a Bluetooth setting screen to the operator terminal 21 in the processing of S203. For example, in a case where the driver state estimation device 111 estimates that the driver has a problem with adjusting the volume, the in-vehicle device 11 may upload a volume setting screen to the operator terminal 21 in the processing of S203. For example, in a case where the driver state estimation device 111 estimates that the driver has a problem with the operation of the air conditioner, the in-vehicle device 11 may upload an air conditioner option screen to the operator terminal 21 in the processing of S203.

### Technical Effect

The automobile company often operates a call center (for example, the call center 20) that allows a driver who drives a vehicle (for example, the vehicle 10) to inquire about at least one of the in-vehicle device (for example, the in-vehicle device 11) and the vehicle operation. Here, the operator of the call center often takes time for the conversation to understand the problem of the driver who makes the inquiry. In order to reduce the time until the operator understands the problem of the driver, a method is considered in which the in-vehicle device of the vehicle uploads the currently displayed screen to the call center. However, the screen currently displayed on the in-vehicle device is often a screen for making an inquiry to the call center. Therefore, even in a case where the screen currently displayed on the in-vehicle device is uploaded to the call center, it is difficult for the operator to understand the driver's problem from the uploaded screen.

On the other hand, in the present embodiment, the driver state estimation device 111 estimates that the driver has a problem. Then, before the driver of the vehicle 10 makes an inquiry to the call center 20, at least one of the screen of the in-vehicle device 11 related to the problem of the driver and the warning light screen is uploaded to the call center 20 (operator terminal 21). As a result, in a case where the driver of the vehicle 10 makes an inquiry to the call center 20, the operator of the call center 20 can relatively quickly understand the problem of the driver from at least one of the uploaded screen of the in-vehicle device 11 and the warning light screen. In addition, even in a case where the screen of the in-vehicle device 11 at the time of the inquiry is different from the screen of the in-vehicle device 11 in a case where the driver has a problem, the screen of the in-vehicle device 11 in a case where the driver has a problem can be uploaded to the call center 20. Therefore, with the driver state estimation system 1, the burden on the driver can be reduced.

The aspects of the disclosure derived from the embodiments described above will be described below.

A driver state estimation system according to an aspect of the disclosure transmits, in a case where an estimation is made that a problem occurs to a driver, based on a state of a screen operation operated by the driver, of an in-vehicle terminal device mounted in a vehicle, screen information of the in-vehicle terminal device to a call center.

In an example of the driver state estimation system, the screen information may be transmitted before the driver makes an inquiry to the call center.

The present disclosure is not limited to the above-described embodiments, and can be appropriately modified within the scope not departing from the gist or the idea of the disclosure that can be read from the claims and the entire specification. A driver state estimation system including such modifications is also included in the technical scope of the present disclosure.

What is claimed is:

1. A driver state estimation system that transmits, in a case where an estimation is made that a problem occurs to a driver, based on a state of a screen operation operated by the driver, of an in-vehicle terminal device mounted in a vehicle, screen information of the in-vehicle terminal device to a call center.

2. The driver state estimation system according to claim 1, wherein the screen information is transmitted before the driver makes an inquiry to the call center.
